(19) United States
(12) Patent Application Publication
(10) Pub. No.: US 2026/0320990 A1
(43) Pub. Date: Oct. 15, 2026

(54) SYSTEMS AND METHODS FOR USING EDGE DEVICES IN MULTI-MODAL VISION MODELS

(71) Applicant: E2INTERACTIVE, INC., ATLANTA, GA (US)

(72) Inventors: BOBIN DENG, KENNESAW, GA (US); KAZI FAHIM AHMAD NASIF, KENNESAW, GA (US); NOBEL DHAR, KENNESAW, GA (US); RAHIM SNOW, ATLANTA, GA (US); GEORGE W HARBISON, CUMMING, GA (US); MICHAEL PARLOTTO, SANDY SPRINGS, GA (US)

(21) Appl. No.: 19/643,610

(22) Filed: Apr. 9, 2026

Related U.S. Application Data
(60) Provisional application No. 63/785,762, filed on Apr. 9, 2025.

(51) Int. Cl. G06V 10/80; G06V 40/16

(52) U.S. Cl. CPC G06V 10/80; G06V 40/171; G06V 40/176

(57) ABSTRACT

The present invention is directed to using edge devices in a multimodal vision system for analyzing customer behavior. Systems may include: low-cost edge devices having a processor and a memory; cameras in communication with the edge device; and a multimodal vision model stored in the memory and executed by the processor, the model including an emotion recognition model, a product detection model, and a gaze target estimation model. Methods may include capturing image data from a plurality of camera angles within a retail environment; processing the image data locally on a edge device using a multimodal vision model; identifying a customer's emotion; identifying a product interaction; estimating a customer's gaze target to bridge customer interaction with products in real-time or near real-time; and analyzing the identified emotions and gaze targets to determine product placement strategies.

### RELATED APPLICATIONS

The present invention claims priority to U.S. Provisional Patent Application No. 63/785,762, entitled “Systems and Methods for Using Edge Devices in Multimodal Vision Models,” filed on 9 Apr. 2025, which is incorporated by reference herein in its entirety.

### FIELD OF THE INVENTION

In general, the present invention is directed to systems and methods for utilizing multimodal computer vision models deployed on one or more edge devices. More specifically, the present invention is directed to a multimodal computer vision model applied to customer shopping behaviors.

### BACKGROUND

While large-scale Artificial Intelligence (AI) models have demonstrated an acceptable ability to complete specific, isolated tasks, they remain largely incapable of independently managing complex, general-world applications. Furthermore, recent industry observations suggest that the “scaling law” for these massive models has reached a point of diminishing returns.

Consequently, the AI field is undergoing a structural transition similar to the semiconductor industry's shift from single large cores to multiple small, collaborative cores within a single chip. The focus is moving toward the deployment of multiple lightweight AI models that work in concert to achieve sophisticated objectives.

The integration of computer vision models directly into edge devices-rather than relying on remote data centers-represents a significant leap in data processing. This shift provides several critical advantages, including (i) Reduced Latency: Local processing ensures lower response times; (ii) Bandwidth Efficiency: Edge devices require significantly less network bandwidth, and in some cases, can operate without a network connection entirely; (iii) Enhanced Privacy: By processing data locally, these systems offer stronger data privacy protections; and/or (iv) Reduced Operational Costs: Local processing decreases energy consumption and lowers the computing pressure on centralized data centers.

Edge computing may be particularly transformative in the retail sector, where it enables intelligent monitoring systems and personalized customer interactions. Edge devices may permit emotion determination, gaze detection, and/or object detection. Emotion determination and gaze detection may be relevant for tailoring personalized advertising and understanding consumer sentiment. Object detection may permit automated inventory management, and may also improve a consumer's shopping experience by better understanding the options before the consumer.

Despite the benefits of edge-based AI, significant hurdles remain. Running multiple vision models simultaneously on a single device dramatically increases the demand on system resources, creating complex integration challenges.

Currently, many high-performance frameworks are unsuitable for low-cost edge hardware. For instance, the Gaze-LLE approach for gaze target estimation is too resource-intensive for devices like the Raspberry Pi 5, often resulting in processing latencies of over fifteen (15) seconds per frame.

There is, therefore, a pressing need for a cost-effective and energy-efficient solution that can implement multimodal computer vision-specifically combining emotion, gaze, and product detection-on low-cost edge devices without sacrificing real-time performance or accuracy.

Therefore, it may be desirable to implement computer vision solutions on edge devices in order to offer cost-effective and energy-efficient alternatives to traditional cloud computing approaches. By processing data locally, edge devices may reduce the need for continuous data transmission to the cloud, potentially lowering operational costs and decreasing energy consumption. These benefits may be desirable for scalable deployments across industries where both economic and environmental considerations are increasingly paramount.

### SUMMARY OF THE INVENTION

In accordance with some embodiments of the present invention, systems and methos may include aspects such as a system for analyzing customer behavior using a multimodal vision model, the system comprising: at least one low-cost edge device comprising a processor and a memory; a plurality of cameras in communication with the edge device, including at least one top-middle camera and at least one side camera; and a multimodal vision model stored in the memory and executed by the processor, the model comprising at least two emotion recognition models, a product detection model, and a gaze target estimation model.

In accordance with some embodiments of the present invention, systems and methos may include aspects such as a method for utilizing a multimodal computer vision model on an edge device, the method comprising: capturing image data from a plurality of camera angles within a retail environment; processing the image data locally on a low-cost edge device using a multimodal vision model; identifying a customer's emotion using at least one emotion recognition model; identifying a product interaction using a product detection model; estimating a customer's gaze target using a gaze target estimation model to bridge customer interaction with products in real-time or near real-time; and analyzing the identified emotions and gaze targets to determine product placement strategies.

These and other aspects will become apparent from the following description of the invention taken in conjunction with the following drawings, although variations and modifications may be affected without departing from the spirit and scope of the novel concepts of the invention.

### DESCRIPTION OF THE FIGURES

The present invention can be more fully understood by reading the following detailed description together with the accompanying drawings, in which like reference indicators are used to designate like elements. The accompanying figures depict certain illustrative embodiments and may aid in understanding the following detailed description.

Before any embodiment of the invention is explained in detail, it is to be understood that the invention is not limited in its application to the details of construction and the arrangements of components set forth in the following description or illustrated in the drawings. The embodiments depicted are to be understood as exemplary and in no way limiting of the overall scope of the invention. Also, it is to be understood that the phraseology and terminology used herein is for the purpose of description and should not be regarded as limiting. The detailed description will make reference to the following figures, in which:

FIG. 1 illustrates an exemplary system, in accordance with some embodiments of the present invention.

FIG. 2 depicts exemplary customer emotions from a side camera, in accordance with some embodiments of the present invention.

FIG. 3 depicts exemplary customer emotions from a top-mid camera, in accordance with some embodiments of the present invention.

FIG. 4 illustrates exemplary emotion recognition and gaze estimation from a side camera, in accordance with some embodiments of the present invention.

FIG. 5 illustrates an exemplary hardware arrangement, as utilized in some embodiments of the present invention.

FIG. 6 illustrates exemplary central processing unit (CPU) and graphics processing units (GPU) utilization of an emotion model, across various edge devices, in accordance with some embodiments of the present invention.

FIG. 7 illustrates exemplary CPU and GPU utilization of gaze detection models, across various edge devices, in accordance with some embodiments of the present invention.

FIG. 8 illustrates exemplary CPU and GPU utilization of combined models, across various edge devices, in accordance with some embodiments of the present invention.

FIG. 9 illustrates exemplary memory utilization for emotion detection models, across various edge devices, in accordance with some embodiments of the present invention.

FIG. 10 illustrates exemplary memory utilization for gaze detection models, across various edge devices, in accordance with some embodiments of the present invention.

FIG. 11 illustrates exemplary memory utilization for combined emotion, gaze, and object detection models, across various edge devices, in accordance with some embodiments of the present invention.

FIG. 12 illustrates exemplary disk busy rates of emotion detection models, across various edge devices, in accordance with some embodiments of the present invention.

FIG. 13 illustrates exemplary disk busy rates of gaze models, across various edge devices, in accordance with some embodiments of the present invention.

FIG. 14 illustrates exemplary disk busy rates of combined emotion, gaze, and

product determination models, across various edge devices, in accordance with some embodiments of the present invention.

FIG. 15 illustrates exemplary swap area utilization of an emotion detection model, across various edge devices, in accordance with some embodiments of the present invention.

FIG. 16 illustrates exemplary swap area utilization of a gaze detection model, across various edge devices, in accordance with some embodiments of the present invention.

FIG. 17 illustrates exemplary swap area utilization of combined emotion, gaze, and object determination models, across various edge devices, in accordance with some embodiments of the present invention.

FIG. 18 illustrates exemplary comparison of average latency for different combination of AI models, across various edge devices, in accordance with some embodiments of the present invention.

### DETAILED DESCRIPTION

Before any embodiment of the invention is explained in detail, it is to be understood that the present invention is not limited in its application to the details of construction and the arrangements of components set forth in the following description or illustrated in the drawings. The present invention is capable of other embodiments and of being practiced or being carried out in various ways. Also, it is to be understood that the phraseology and terminology used herein is for the purpose of description and should not be regarded as limiting.

The matters exemplified in this description are provided to assist in a comprehensive understanding of various exemplary embodiments disclosed with reference to the accompanying figures. Accordingly, those of ordinary skill in the art will recognize that various changes and modifications of the exemplary embodiments described herein can be made without departing from the spirit and scope of the claimed invention. Descriptions of well-known functions and constructions are omitted for clarity and conciseness. Moreover, as used herein, the singular may be interpreted in the plural, and alternately, any term in the plural may be interpreted to be in the singular.

In general, multimodal AI Models have become popular since they may serve more complicated real-world applications better than single large models. Instead of serving AI models located at remote data centers, multimodal models may be offloaded onto edge devices. This may provide many benefits, including for example, less response latency, better data privacy, less or no network bandwidth requirements, and/or lower computing pressure on data center. The present invention is directed to systems and methods for deploying multimodal vision models on low-cost edge devices. In accordance with some embodiments of the present invention, systems may comprise four (4) foundation models: two (2) for emotion recognition, one (1) for product detection, and one (1) for gaze target estimation) and related custom datasets. One goal of some embodiments of the present invention may be to utilize computing resources on low-cost edge devices, (for example, including off-the-shelf items such as but not limited to Raspberry PI and Nvidia Jetson Orin), and therefore corresponding systems and methods may be carefully tailored to a multimodal vision model, providing a lightweight system while maintaining acceptable accuracy.

In accordance with some embodiments of the present invention, a new multi-modal vision model has been built as a benchmark for studying customer shopping behaviors and analyzing resource usage status. In an exemplary embodiment, functionality of this multi-modal vision model may comprise two (2) emotion recognition models, one (1) product detection model, and one (1) gaze target estimation model. In some embodiments, multiple AI models may be executed or run in real-time or near real-time on an edge device by threading and context switching, increasing intra-device AI parallelism. Such AI models may be deployed on edge devices with inter-device AI parallelism, reducing dependency on larger servers.

In addition to full functionality of a model, different subsets of model combinations may also be evaluated. Because these subset combinations may also effectively offer intelligence to many applications, resource usage analysis may provide insights for edge deployment and future edge system design. Note that while the present application primarily discusses a customer study system, it is contemplated that such systems may also find applications in many other edge-based multi-modal AI applications, including but not limited to visual impairment assistance, sign language translation, smart drone or robots for precise agriculture, AI-integrated AR glass, etc.

In accordance with some embodiments of the present invention, multi-modal vision model analysis on edge device deployment may provide systematic insights for future AI-based system development.

For example, in accordance with some embodiments of the present invention a new multi-modal vision model may be developed that may analyze customer shopping experience, such a model may include multiple vision models with new created datasets, including those directed to emotion recognition, product detection, and gaze target estimation.

In some embodiments, a multimodal vision model may be tailored to ensure it can simultaneously (or near simultaneously) execute on multiple devices while maintaining acceptable accuracy.

In some embodiments, resource usage status of edge devices may be evaluated when serving multi-modal model (or different subsets). By analyzing the experimental data, insights such as how many foundation AI models the devices can support and what resources may be increased to better service more complicated multi-modal models may be determined or identified.

As noted above, in accordance with some embodiments of the present invention, a multimodal model may be developed for a customer behavior study. This customer study system may attempt to determine desirable product placement plans by, for example, collecting and analyzing customer gaze targets and emotions, aiming to provide better shopping experiences to customers and increase product sales. This multimodal model may consist of four (4) foundation vision models: two (2) emotion recognition models, one (1) product detection model, and one (1) gaze target estimation model.

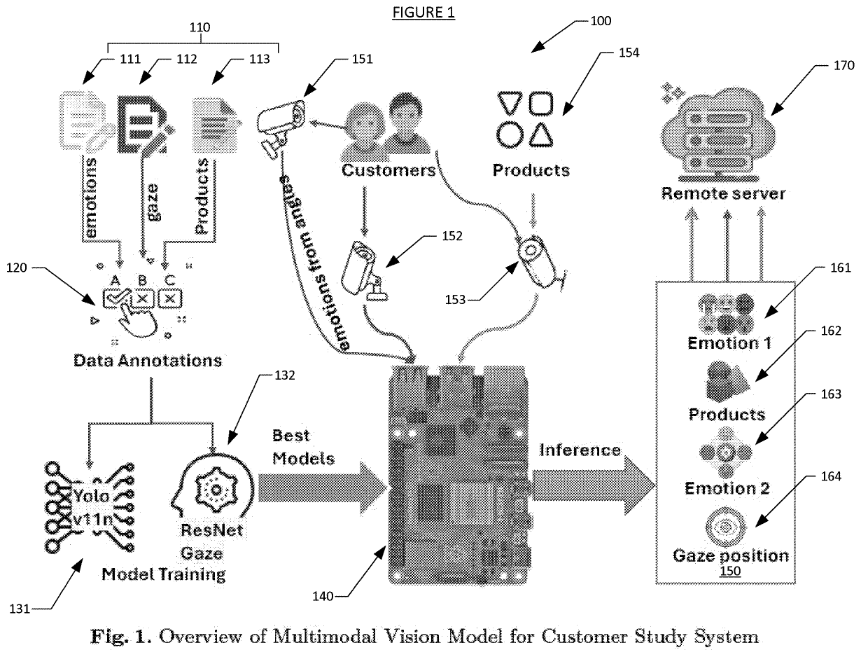

As noted above, the present invention relates to systems and methods for deploying multimodal vision models on low-cost edge devices to analyze customer shopping behaviors. As illustrated in FIG. 1, the system architecture utilizes local processing to reduce response latency, enhance data privacy, and minimize network bandwidth requirements. Exemplary edge devices for this system may include the Raspberry Pi 4 (8 GB RAM), various configurations of the Raspberry Pi 5 (2 GB, 4 GB, 8 GB, and 16 GB RAM), and the Nvidia Jetson Orin Nano.

With reference to FIG. 1, a system 100 in accordance with some embodiments of the present invention will now be discussed. Systems 100 may comprise one or more AI models 110 directed to customer emotion determination 111, customer gaze estimation 112, and/or retailer product determination 113.

Such AI models may feed and draw from database 120, which may comprise both training data, and over time, data from practice. Database 120 may provide information to AI models which may be at Yolo v11n 131 and/or ResNet Gaze 132 models. Once models are trained (and/or updated), they may be pushed to edge device 140.

Edge device 140 may, in operation, receive inputs from cameras 151, 152, 153. Edge device 140 may also receive a list of products and information pertaining thereto at 154. This may include, for example, images and pictures of products 154 from various angles or orientations.

Utilizing the inputs from cameras 151, 152, 153 and applying the same to local AI models on the edge device may permit the determination or estimation of emotions, gaze, and interested products. AI models on edge device 140 may determine—with a degree of confidence—a customer experience 160, which may comprise a first emotion 161, products the customer may be interested in 162, a second emotion 163, and/or a gaze position 164 of the customer—that is, where the customer was looking. Such information may be sent to and saved at a remote server 170 for subsequent processing or reference.

Considering the comprehensive retail environments, it appears that at least one (1), but preferably three (3) cameras may be desirable to capture a customer's emotions. One (1) camera may be placed in the top-middle of the rack, and two (2) may be placed on both the left and right sides. Side cameras address challenges in detecting emotions when customers look downwards, where the top-middle cannot capture faces.

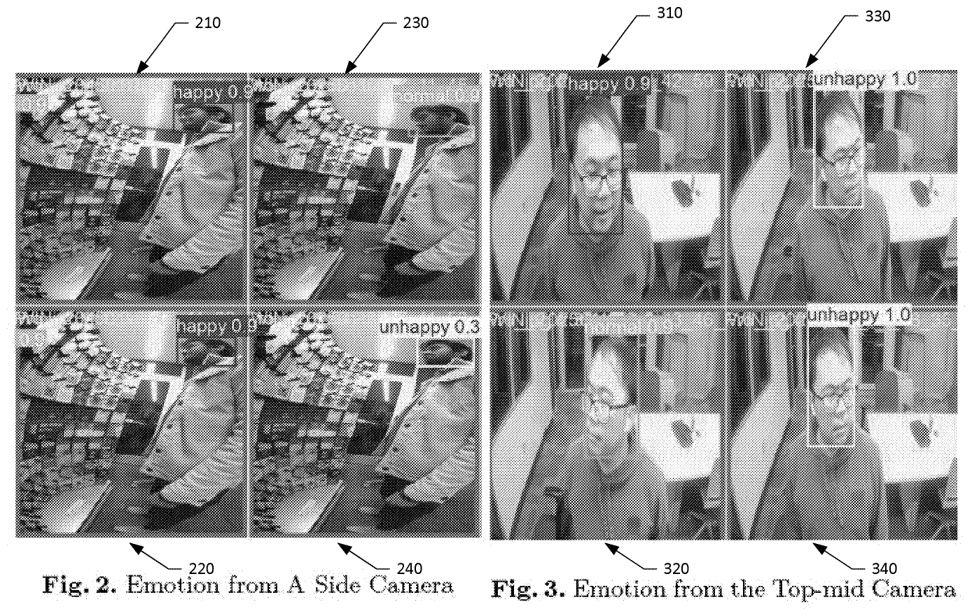

Because of the limited resources on such exemplary edge devices, frames from the left and right cameras may be combined and fill the merged frame into the same Yolo model, thereby potentially reducing computation costs. FIG. 2 shows the unmerged detection from the left camera, and FIG. 3 presents the emotion output from top-middle cameras.

In accordance with some embodiments of the present invention, a physical hardware implementation, such as illustrated in FIG. 5, may typically include a processor (such as a Raspberry Pi 5), a standard webcam, and a wide-range side camera (such as, but not limited to an angle of view of a 160-degree or 180-degree). In a retail environment, the webcam is ideally installed at the top-middle of a product rack (e.g., a gift card rack) to capture customer emotions. The wide-range side camera is utilized to estimate the customer's gaze target and provide a complementary view of the customer's emotions. This dual-camera approach ensures that facial data is captured even when a customer looks toward the bottom of the rack, a position where the top-middle camera may lose visibility of the face.

Table 1 summarize the edge devices utilized in our experiments, which include Raspberry Pi 4 (8 GB RAM), Raspberry Pi 5 (2 GB RAM), Raspberry Pi 5 (4 GB RAM), Raspberry Pi 5 (8 GB RAM), Raspberry Pi 5 (16 GB RAM), and Nvidia Jetson Orin Nano.

TABLE 1
Hardware Configurations of Edge Devices in Evaluations

| | | | CPU | | CUDA |
|---|---|---|---|---|---|
| Device | RAM | CPU Freq. | Cores | Storage | Cores |
| Pi 4 (8 GB) | 8 GB | 1.8 GHz | 4 | 32 GB | N/A |
| Pi 5 (2 GB) | 2 GB | 2.4 GHz | 4 | 32 GB | N/A |
| Pi 5 (4 GB) | 4 GB | 2.4 GHz | 4 | 32 GB | N/A |
| Pi 5 (8 GB) | 8 GB | 2.4 GHz | 4 | 32 GB | N/A |
| Pi 5 (16 GB) | 16 GB | 2.4 GHz | 4 | 32 GB | N/A |
| Jetson Orin Nano | 8 GB | 1.7 GHz | 6 | 64 GB | 1024 |

The multimodal vision model is designed as a benchmark for studying shopping behaviors through four foundation models:

Emotion Recognition Models (×2): These models may utilize a YOLO v11 nano (YOLOv11n) architecture due to its high recognition capability and low computational requirements. As seen in FIG. 2, these models categorize emotions into three classes: happy 210, 220; unhappy 240, and neutral 230. Similarly, as seen in FIG. 3 models may categorize emotions into happy 310; neutral 320; and unhappy 330, 340. Note that additional emotions are contemplated to be determined, such as but not limited to interested, agitated, confused, content, pleased, etc.

Product Detection Model: This model may also leverages the YOLOv11n foundation, fine-tuned with custom datasets to identify products the customer interacts with in real-time.

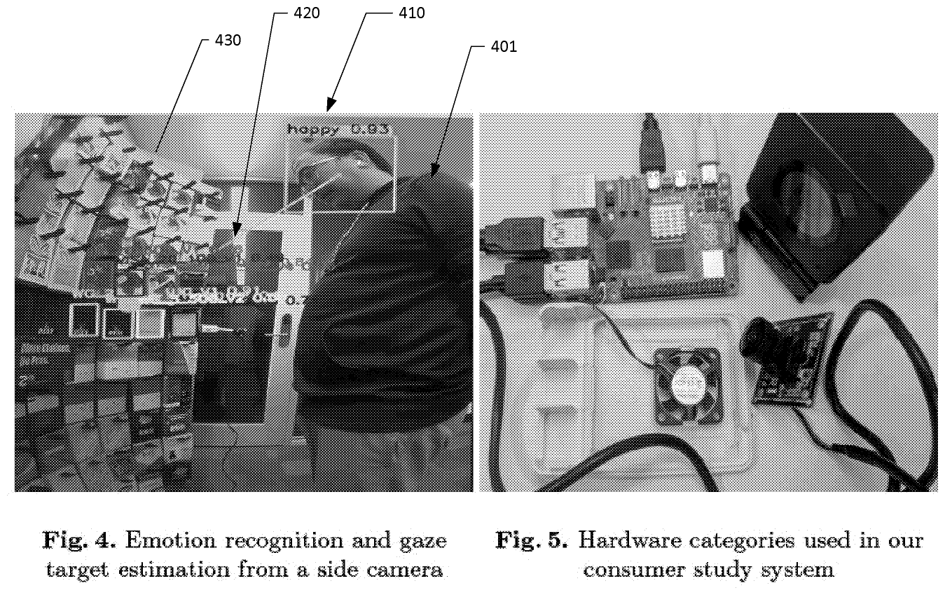

Gaze Target Estimation Model: A ResNet 50 foundation model may be used for gaze estimation. This model may bridge the gap between customer emotion and specific product interaction. An exemplary output of this model from a side camera is shown in FIG. 4. With reference to FIG. 4, it can be seen that an emotion of a customer 401 is identified as happy at 410. It is determined where a customer is looking (via gaze estimation) at 420, and the product at which the customer appears to be looking at 430.

To optimize resource usage on edge devices, frames from the left and right side cameras may be merged into a single frame before being fed into the model, effectively reducing computation costs.

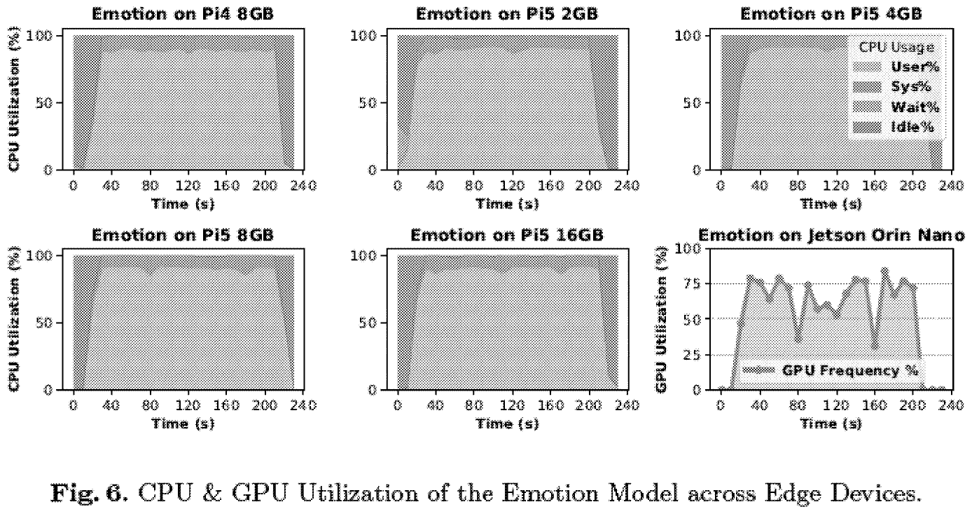

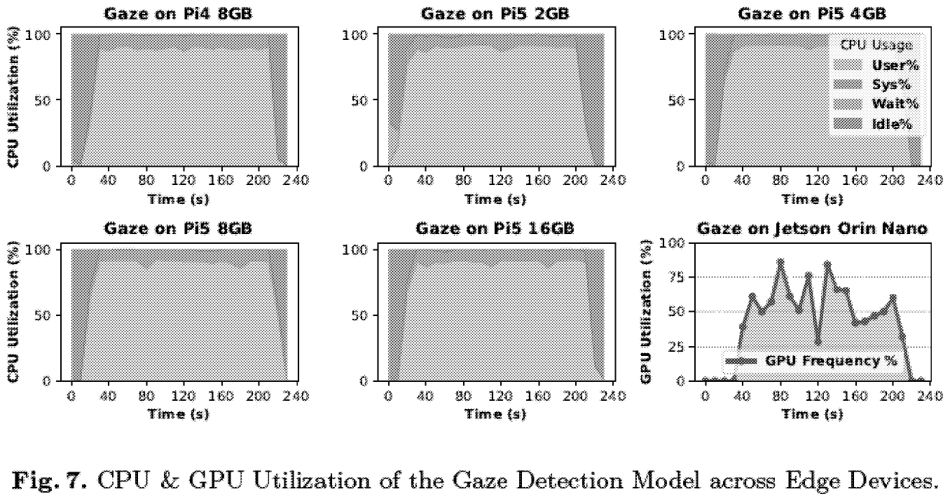

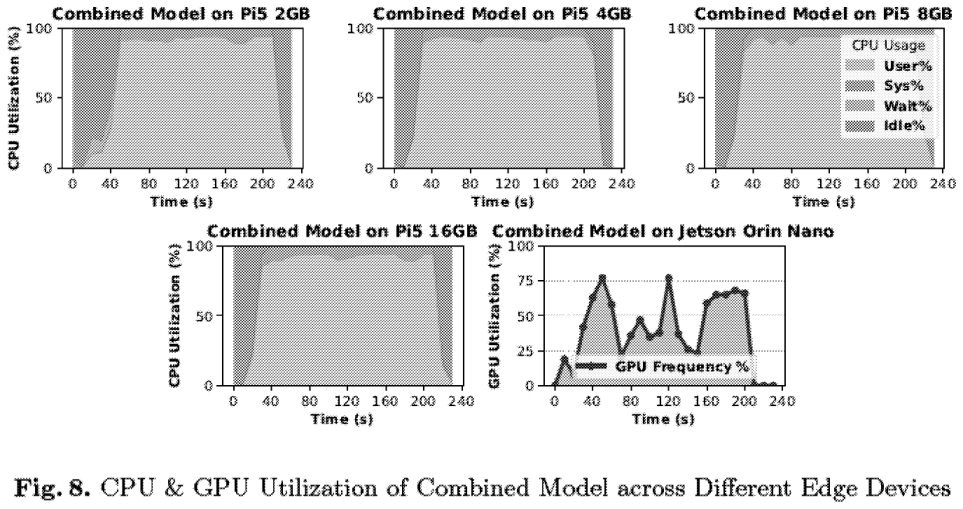

Evaluation of the system across different hardware platforms reveals specific resource bottlenecks and performance capabilities. For Raspberry Pi devices, average CPU utilization consistently reaches nearly 100% when running emotion or gaze models, indicating that the CPU is a primary bottleneck. In contrast, the Nvidia Jetson Orin Nano, which utilizes an on-device GPU, maintains an average GPU utilization rate of less than 75%. While Raspberry Pi devices may be forced to skip frames to maintain processing, the Jetson Orin Nano demonstrates sufficient capability to process live-stream data without frame loss. FIGS. 6, 7, and 8 illustrate these utilization patterns for single and combined models.

Memory distribution varies significantly by RAM capacity. For example:

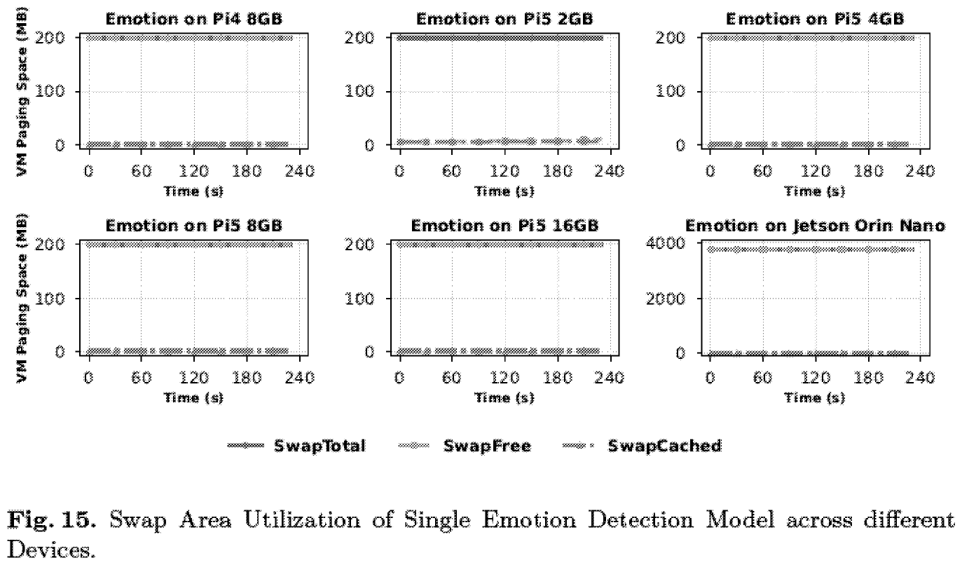

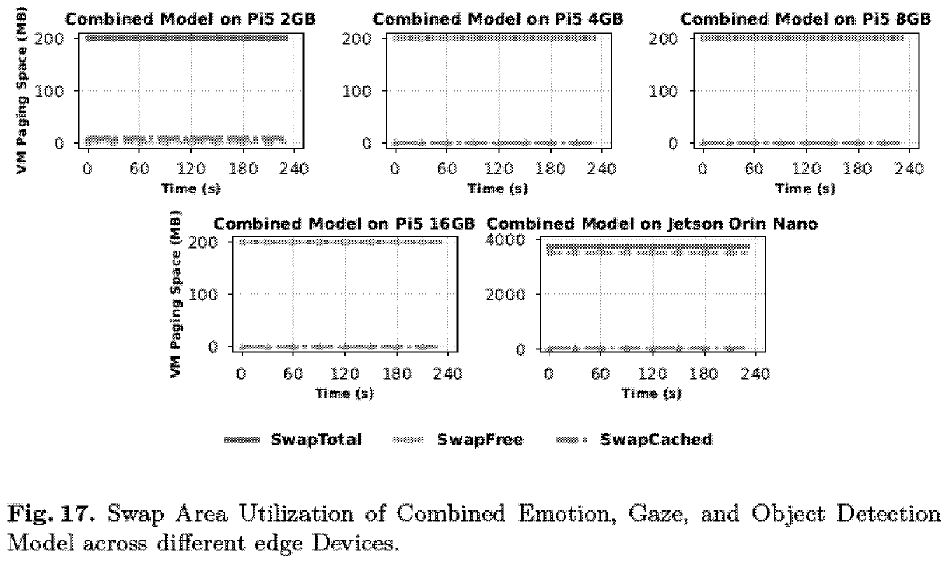

Raspberry Pi 5 (2 GB): Experiences extreme memory pressure (up to 82.8% utilization for combined models) and relies heavily on swap memory, which can lead to performance bottlenecks. FIG. 15 and FIG. 17 show the full utilization of the swap area in 2 GB models.

Raspberry Pi 5 (4 GB and 8 GB): These configurations offer a more balanced memory profile with stable active memory and sufficient headroom for model expansion.

Nvidia Jetson Orin Nano: Maintains moderate memory utilization (approx. 64.9% for combined models) and uses shared GPU memory for efficient processing.

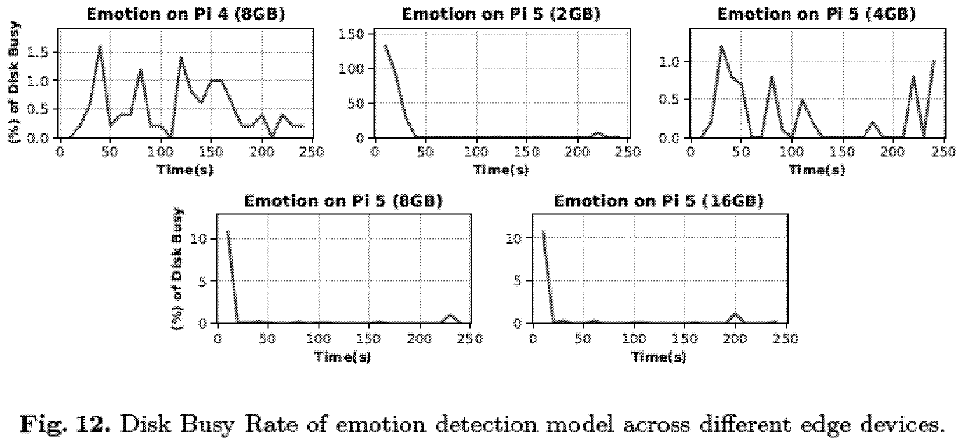

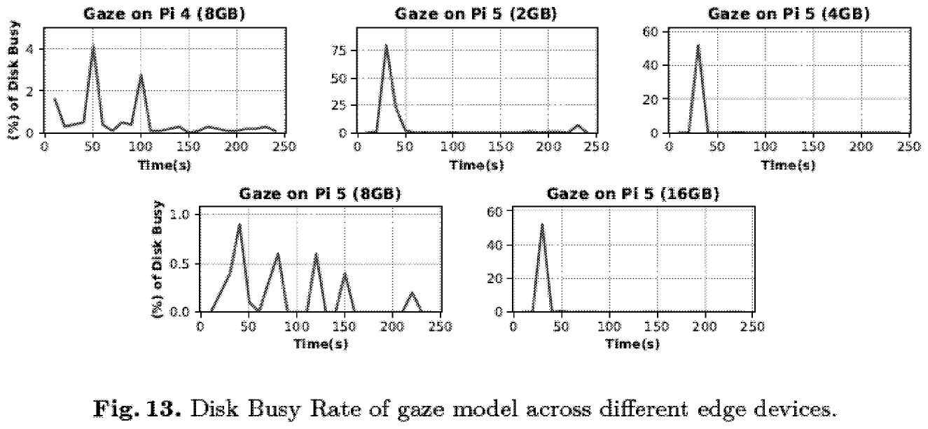

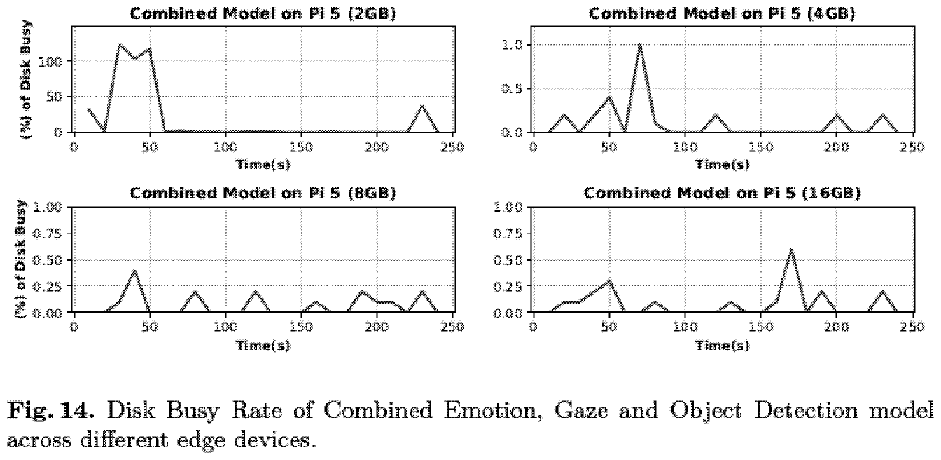

Disk busy rates generally spike during initial model loading (as seen in FIGS. 12, 13, and 14) but stabilize once the models are loaded into RAM, except in the 2 GB Pi 5 where disk caching remains higher due to RAM limitations.

TABLE 2
Average FPS for Combined Models on Different Edge Devices

| | | | | Gaze & | Emotion, |
|---|---|---|---|---|---|
| Device | Emotion | Gaze | Object | Object | Gase & Object |
| Pi 4 (8 GB) | 0.77 | 0.21 | 0.76 | 0.15 | N/A |
| Pi 5 (2 GB) | 1.87 | 0.57 | 1.82 | 0.41 | 0.23 |
| Pi 5 (4 GB) | 2.29 | 0.61 | 1.78 | 0.44 | 0.25 |
| Pi 5 (8 GB) | 2.05 | 0.62 | 1.97 | 0.48 | 0.26 |
| Pi 5 (16 GB) | 1.88 | 0.69 | 1.92 | 0.53 | 0.32 |
| Jetson Orin | 23.05 | 3.24 | 22.90 | 3.12 | 2.95 |
| Nano | | | | | |

Table 2 (above) illustrates average frames per second captured for combined models on different edge devices.

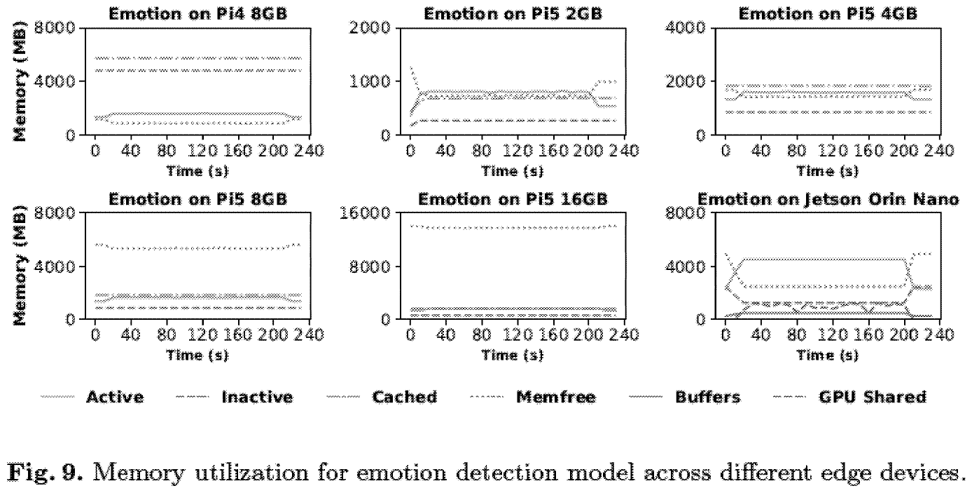

FIG. 9 sets forth memory utilization for emotion detection models across different edge devices. Pi4 (8 GB) maintains stable memory with high cache (5.7 GB) and moderate active memory (1.3-1.6 GB), while Pi5 (2 GB) operates with minimal cache (675 MB) and higher active-to-free memory ratio. Pi5 (4 GB) shows balanced memory distribution with consistent cache (1.8 GB) and stable active memory (1.6 GB). Pi5 (8 GB) demonstrates substantial free memory (5.3 GB) with efficient caching (1.85 GB), and Pi5 (16 GB) exhibits exceptional free memory availability (13.7 GB) with proportionally scaled caching (1.6 GB). Jetson shows stable memory usage of active memory (4.48 GB) and while using a small amount of buffer and GPU shared memory.

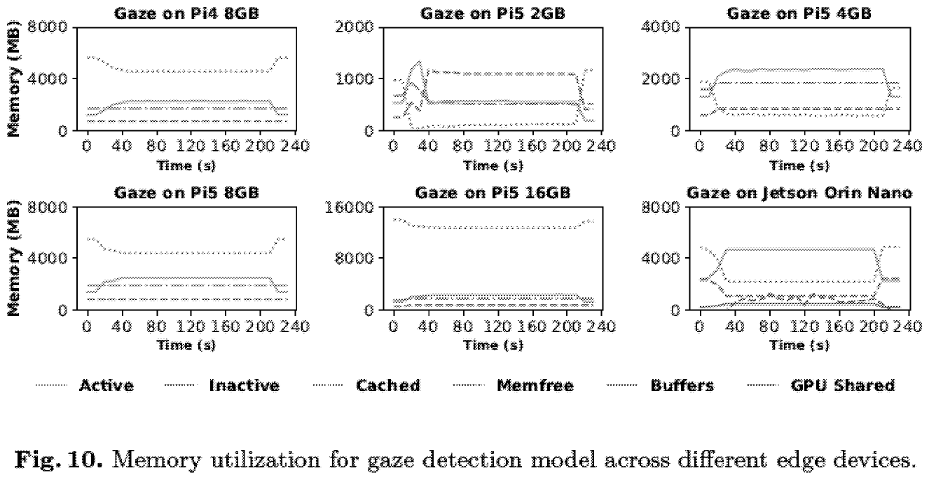

FIG. 10 illustrates memory utilization for gaze estimation across different edge devices. It can be seen that Pi5 (2 GB) may experience highest memory utilization of 86.7%, while Pi5 (16 GB) may maintain a low utilization at 20.2%. Pi4 (8 GB) and Pi5 (8 GB) may demonstrate similar memory profiles (38.5% and 42.7% respectively). Jetson Orin Nano demonstrates moderate memory usage.

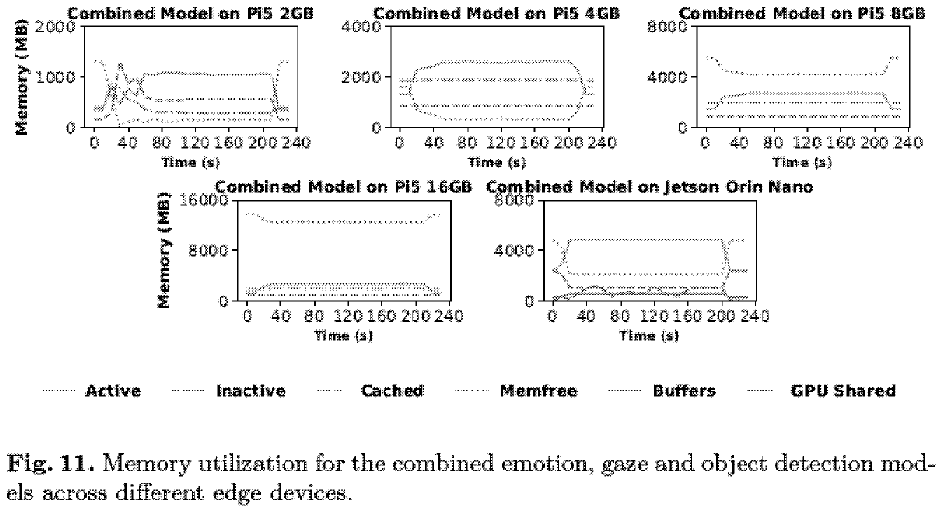

FIG. 11 illustrates memory utilization for combined models (emotion, gaze, and card detection) across different edge devices. FIG. 11 does show significant memory demands across all platforms. Pi5 (2 GB) and Pi5 (4 GB) experience extreme memory pressure with 82.8% and 85.6% utilization respectively, indicating potential performance bottlenecks. As shown in FIG. 11, the Jetson Orin Nano demonstrates moderate memory utilization at 64.9% of its 7.5 GB RAM, offering better balance than lower-memory Pi configurations. Pi5 (8 GB) maintains reasonable headroom with 44.8% utilization, while Pi5 (16 GB) shows substantial excess capacity with 21.6% utilization, suggesting it may be oversized for the applied workload.

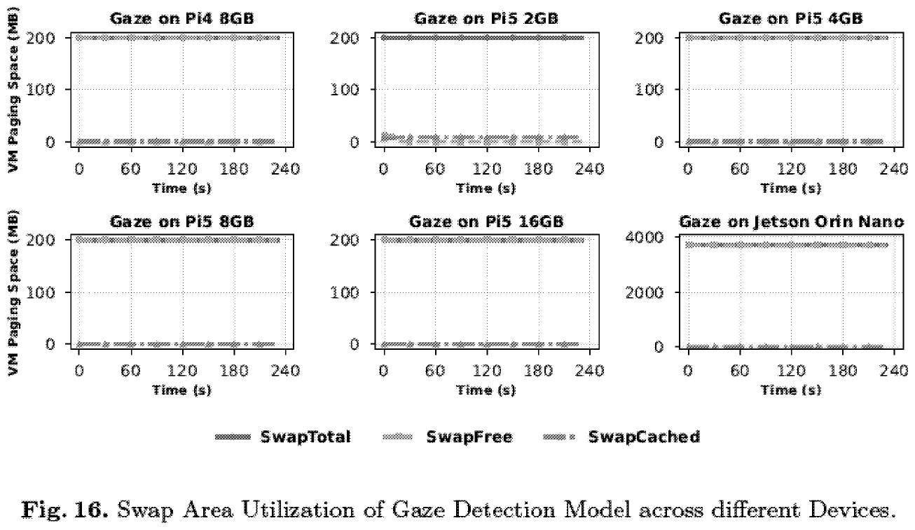

FIG. 15 illustrates swap area utilization of a single emotion detection model across different devices. Note that FIG. 15 shows that while running emotion detection model, Raspberry Pi5 (2 GB) may utilizes full swap memory because of its limited RAM. Swap memory was not present in other devices. A swap usage for gaze detection model may be similar to an emotion detection model. As shown in FIG. 16, a Raspberry Pi5 (2 GB) may utilize full amount of swap memory leaving little to no free swap memory and may also use 8 MB of swap cached. In other edge devices the full amount of swap memory may be left free.

FIG. 17 illustrates a swap area utilization of combined emotion, gaze, and object detection across different edge devices. FIG. 17 demonstrates that Raspberry Pi4 may be unable to run three AI models together. Raspberry Pi5 (2 GB) may utilize a full amount of swap area. Physical RAM may be enough for other Raspberry Pi5 devices. Jetson Orin Nano may utilize some swap area, for example because of model loading and data transfer into CUDA libraries.

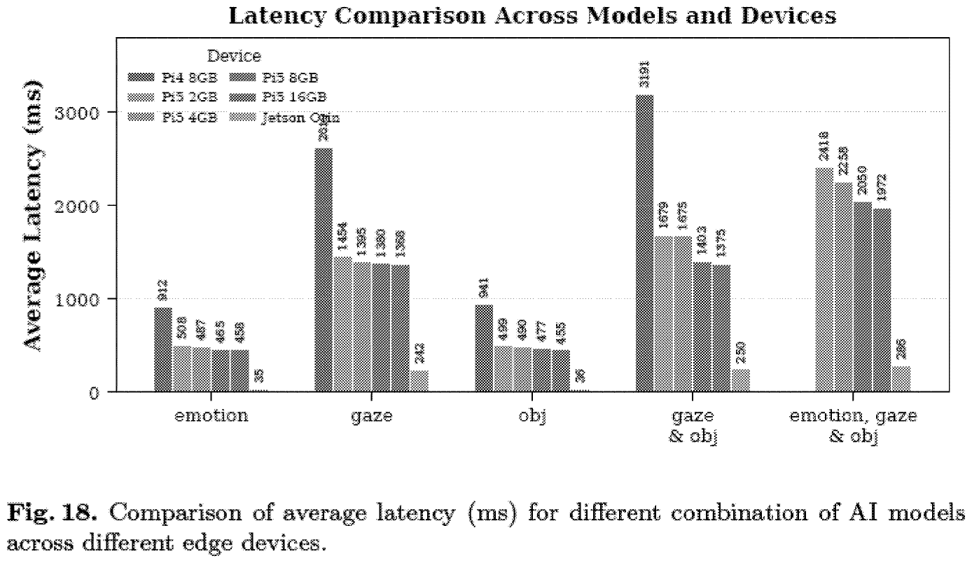

Latency data, summarized in FIG. 18, dictates the suitability of each device for specific retail applications:

Single Model Tasks: For basic emotion detection, Raspberry Pi 4 exhibits a latency of 912 ms, while Raspberry Pi 5 reduces this to approximately 458-508 ms. The Jetson Orin Nano achieves a drastically lower latency of 35 ms.

Combined Multimodal Tasks: When combining emotion, gaze, and object detection, the Raspberry Pi 4 often fails to load the models or exceeds desirable real-time processing limits. The Raspberry Pi 5 shows latency between 1972 ms and 2418 ms for the combined trio. The Jetson Orin Nano maintains a highly efficient latency of 286 ms for the triple-model configuration.

For retail environments requiring real-time or near real-time inference, the Nvidia Jetson Orin Nano is recommended. However, for cost-effective solutions where some latency is tolerable, a Raspberry Pi 5 with at least 4 GB of RAM is identified as a viable alternative

It will be understood that the specific embodiments of the present invention shown and described herein are exemplary only. Numerous variations, changes, substitutions and equivalents will now occur to those skilled in the art without departing from the spirit and scope of the invention. Accordingly, it is intended that all subject matter described herein and shown in the accompanying drawings be regarded as illustrative only, and not in a limiting sense.

What is claimed is:

1. A system for analyzing customer behavior using a multimodal vision model, the system comprising:
at least one low-cost edge device comprising a processor and a memory;
a plurality of cameras in communication with the edge device, including at least one top-middle camera and at least one side camera; and
a multimodal vision model stored in the memory and executed by the processor, the model comprising at least two emotion recognition models, a product detection model, and a gaze target estimation model.

2. The system of claim 1, wherein the edge device increases intra-device AI parallelism through threading and context switching to run the multiple models in real-time or near real-time.

3. The system of claim 1, wherein the plurality of cameras comprises a first camera placed at the top-middle of a product rack and at least two side cameras placed on the left and right sides of the rack.

4. The system of claim 3, wherein the processor is configured to merge frames from the left and right side cameras into a single merged frame for processing by a single emotion detection model to reduce computational costs.

5. The system of claim 1, wherein the emotion recognition models and the product detection model utilize a YOLO v11 nano (YOLOv11n) foundation model.

6. The system of claim 1, wherein the gaze target estimation model utilizes a ResNet 50 foundation model.

7. The system of claim 1, wherein the edge device is a Raspberry Pi device or an Nvidia Jetson Orin Nano.

8. The system of claim 7, wherein the Raspberry Pi device has at least 4 GB of random access memory (RAM) to avoid performance bottlenecks and swap area utilization when running the combined multimodal model.

9. A method for utilizing a multimodal computer vision model on an edge device, the method comprising:
capturing image data from a plurality of camera angles within a retail environment;
processing the image data locally on a low-cost edge device using a multimodal vision model;
identifying a customer's emotion using at least one emotion recognition model;
identifying a product interaction using a product detection model;
estimating a customer's gaze target using a gaze target estimation model to bridge customer interaction with products in real-time or near real-time; and
analyzing the identified emotions and gaze targets to determine product placement strategies.

10. The method of claim 9, wherein identifying a customer's emotion includes utilizing the side camera to capture facial data when the customer's face is obscured from the top-middle camera due to looking downwards.

11. The method of claim 9, further comprising utilizing a wide-range side camera with a view angle of more than one hundred and sixty (160) degrees to simultaneously estimate a customer's gaze target and capture a side-view emotion.

12. The method of claim 9, wherein identifying a product interaction includes utilizing a product detection model fine-tuned with custom datasets to understand which specific products a customer associates with a real-time emotion.
